(19) United States
(12) Patent Application Publication
(10) Pub. No.: US 2012/0307248 A1
(43) Pub. Date: Dec. 6, 2012

(54) LIQUID TRANSPORTING DEVICE, DETECTING APPARATUS AND METHOD THEREOF

(75) Inventors: Hsueh-Ching Shih, New Taipei City (TW); Kun-Chih Tsai, Hsinchu City (TW); Chih-Cheng Feng, Taipei City (TW); Jia-Huey Tsao, New Taipei City (TW); Chun-Min Su, Taichung City (TW)

(73) Assignee: INDUSTRIAL TECHNOLOGY RESEARCH INSTITUTE, Hsinchu (TW)

(21) Appl. No.: 13/304,697

(22) Filed: Nov. 28, 2011

(30) Foreign Application Priority Data
Jun. 3, 2011 (TW) 100119544

(51) Int. Cl. G01N 21/55; G01N 27/447

(52) U.S. Cl. 356/445; 204/600; 204/643

(57) ABSTRACT

A liquid transporting device using electrowetting on dielectric technique is provided. A sampling liquid is accurately transported on a substrate in a channel-free manner. The sampling liquid is spun off the substrate by a centrifugal force after the sampling liquid has been detected. The liquid transporting device can be applied to a biochemical detecting apparatus and a biochemical detecting method, thereby fulfilling requirements of accurate sample transportation in the biomedical field. The liquid transporting device is simplified to reduce overall costs, thus being helpful for decreasing high prices of biomedical detecting systems.

### CROSS-REFERENCE TO RELATED APPLICATION

This application claims the priority benefit of Taiwan application serial no. 100119544, filed Jun. 3, 2011. The entirety of the above-mentioned patent application is hereby incorporated by reference herein and made a part of this specification.

### BACKGROUND

1. Technical Filed

The disclosure is related to a liquid transporting device, a detecting apparatus and a method thereof which uses electrowetting on dielectric (EWOD) technique.

2. Related Art

High-end detecting systems such as for biomedical detecting purpose are remaining at a soaring price in recent years. A main reason thereof is that the required constituting elements are all precision elements and have high costs. In terms of system composition, some most important subsystems of a biomedical detecting system include: a sensing subsystem, a sample transporting subsystem, a mechanical subsystem, an electronic subsystem, and a software subsystem. If the cost of each subsystem in a high-end biomedical detecting system can be reduced, an overall cost of the detecting system is able to be effectively reduced.

On the other hand, current detecting apparatuses mostly use continuous liquids. The driving techniques are mostly the utilization of pressure difference or using a peristaltic pump to provide a driving force. However, continuous liquid requires a liquid sample completely filled in a channel from a source of the driving force to the detecting apparatus, thereby a great amount of the liquid sample is required. Current biochemical detecting apparatuses are hardly to function with small quantities of samples so a lot of precious samples are wasted. Moreover, the pumps for driving the continuous liquids are voluminous, require high costs to build, cannot be integrated into the system easily and cannot process diversified samples for large-scale analysis. Therefore, demands of miniature and accurate detecting techniques surges with the date.

### SUMMARY

The disclosure provides an exemplary embodiment of a liquid transporting device comprising a substrate and a droplet controlling device disposed on the substrate. The droplet controlling device discretizing a sampling liquid into droplets and generating a driving force for the droplets to transport the sampling. Liquid. The droplet controlling device comprises at least one sampling area used for carrying the sampling liquid, at least one detecting area, used for detecting the sampling liquid, and an electrode rail disposed between the sampling area and the detecting area.

A detecting apparatus provides an exemplary embodiment of a liquid transporting device that comprising : a substrate; a droplet controlling device, disposed on the substrate and used to discretize a sampling liquid into droplets and to generate a driving force for the droplets, so as to transport the sampling liquid, wherein the droplet controlling device comprises at least one sampling area, at least one detecting area and an electrode rail, and the electrode rail is disposed between the sampling area and the detecting area; and a rotating device, wherein the substrate is mounted on the rotating device. The detecting apparatus further having a detector, detecting a reflected light reflected from the detecting area.

The disclosure provides an exemplary embodiment of a detecting method comprises: providing a sampling liquid in at least one sampling area on a substrate, driving a droplet controlling device to discretize the sampling liquid into droplets and generate a driving force for the droplets, transporting the droplets from the sampling area to at least one detecting area, driving a rotating device to rotate the substrate at a first rotating speed, incidenting a light on the detecting area to generate a reflected light, and detecting the reflected light to determine the sampling liquid.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram illustrating a biomedical detecting apparatus according to an embodiment of the disclosure.

FIG. 2 is a magnified view of a portion of the schematic diagram illustrating a biomedical detecting apparatus according to an embodiment of the disclosure.

FIG. 3 is a schematic diagram illustrating the detecting apparatus in a droplet controlling device portion according to an embodiment of the disclosure.

FIG. 4 is a schematic diagram illustrating an electrode pattern according to an embodiment of the disclosure.

### DETAILED DESCRIPTION OF DISCLOSED EMBODIMENTS

By using electrowetting on dielectric (EWOD) technique, continuous sampling liquid is replaced by discrete droplets in the disclosure. In other words, an electric potential energy provided by an external electric field is converted to surface energy between the liquid and a solid surface. Then a force gradient is changed by the voltage, so that the surface energy is converted to a main driving force for moving the droplets.

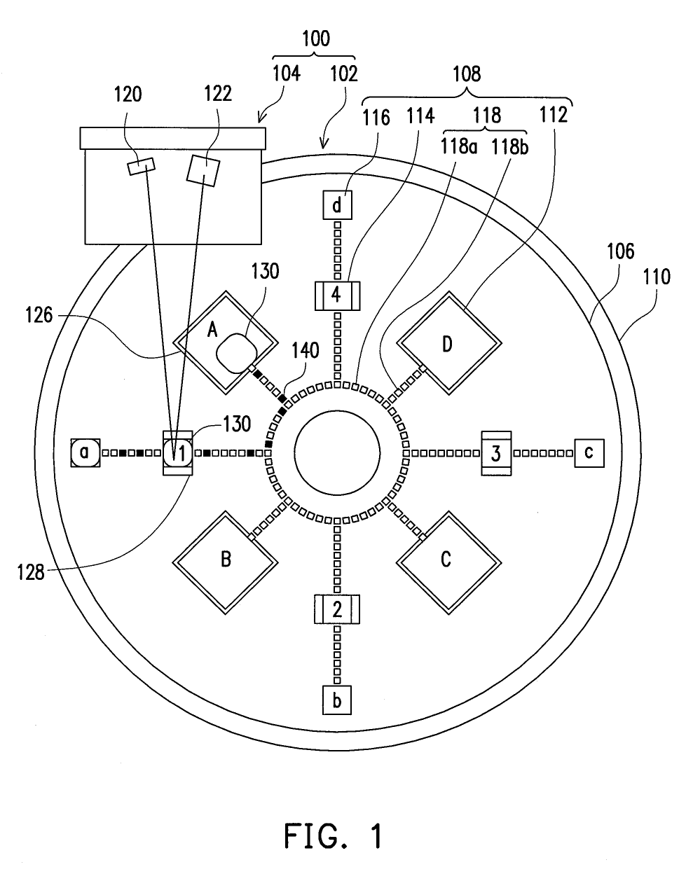

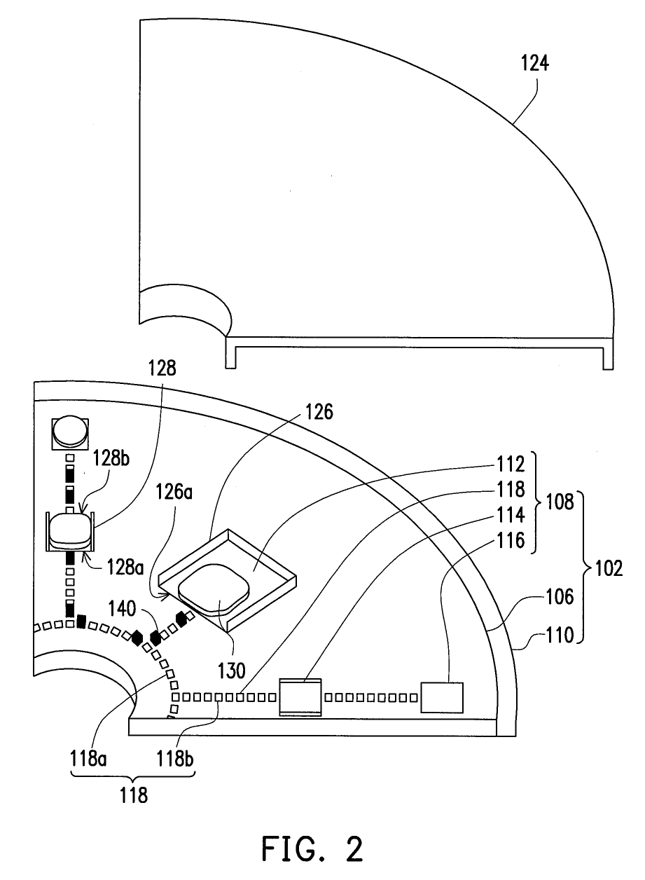

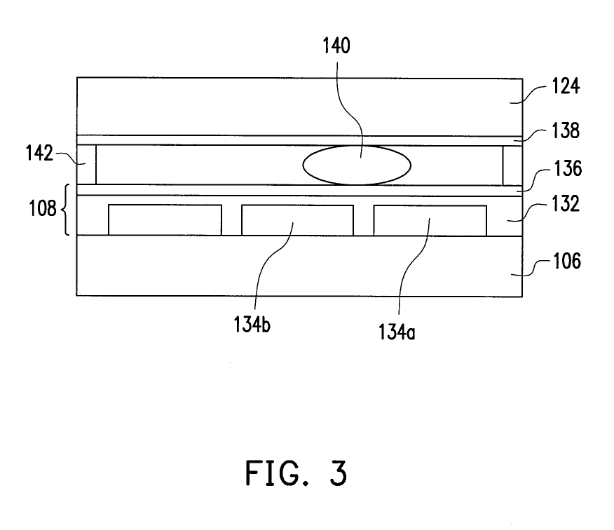

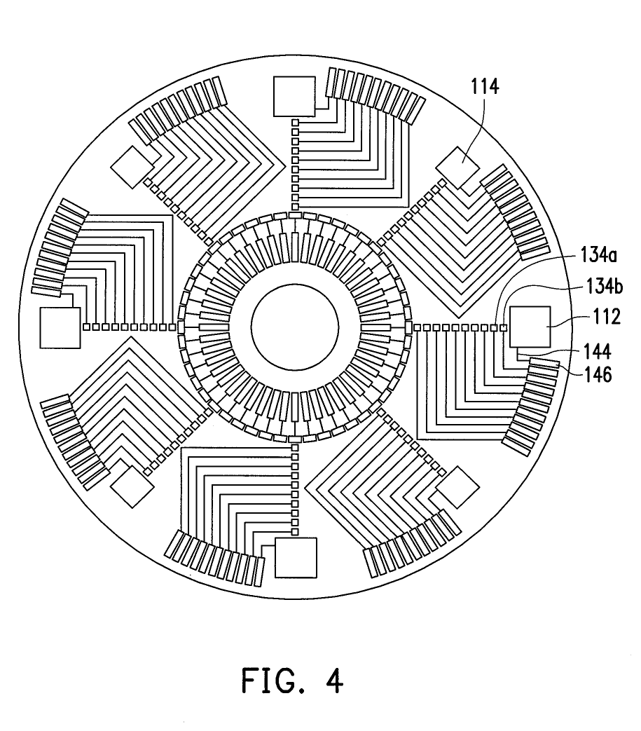

FIG. 1 is a schematic diagram illustrating a detecting apparatus according to an embodiment of the disclosure. FIG. 2 is a magnified view of a portion of the schematic diagram illustrating a detecting apparatus according to an embodiment of the disclosure. FIG. 3 is a schematic diagram illustrating the detecting apparatus in a droplet controlling device portion according to an embodiment of the disclosure. FIG. 4 is a schematic diagram illustrating an electrode pattern according to an embodiment of the disclosure.

As shown in FIG. 1, a detecting apparatus 100 includes a liquid transporting device 102, and an optical device 104.

As shown in FIG. 2, the liquid transporting device 102 includes a substrate 106, a droplet controlling device 108, and a rotating device 110. The substrate 106 is, for example, a circular disk. A material of the substrate 106 is, for example, a plastic material, such as polycarbonate. The substrate 106 is, for example, mounted on the rotating device 110. The droplet controlling device 108 is disposed on the substrate 106 and is used to discretize a sampling liquid 130 into droplets 140 and to generate a driving force for the droplets 140, so as to transport the sampling liquid 130. The droplet controlling device 108 includes at least one sampling area 112, at least one detecting area 114, at least one recycling area 116 and an electrode rail 118. The sampling area 112 is used for carrying the sampling liquid 130. The detecting area 114 is used for detecting the sampling liquid 130. The recycling area 116 is used for recycling the sampling liquid 130 in the detecting area 114.

As shown in FIG. 1, the sampling area 112 according to the present embodiment includes four sections A, B, C, and D. The detecting area 114 includes four sections 1, 2, 3, and 4. The recycling area 116 includes four sections a, b, c, and d. These sections are arranged in a radial manner with the center of the substrate 106 as a reference point. The numbers of the sections in the sampling area 112, the detecting area 114 and the recycling area 116 may be configured according to actual requirements and are not specifically limited.

The electrode rail 118 includes a circular electrode rail 118a and a radial electrode rail 118b. The circular electrode rail 118a and the substrate 160 have the same center, thus forming concentric circles. A plurality of radial electrode rails 118b radially extend from the circular electrode rail 118a, so as to connect the sampling area 112 and the detecting area 114, meaning that the sampling area 112 and the detecting area 114 are located on different radial electrode rails 118b. The detecting area 114 and the recycling area 116 are located on the same radial electrode rails 118b, so that the radial electrode rails 118b extend outward from the detecting area 114 to the recycling area 116, and the radial electrode rails 118b connect the detecting area 114 and the recycling area 116. In other words, the electrode rails 118 are disposed in a manner such that each of the sections of the sample area 112 and each of the sections of the detecting area 114 are connected. Therefore, a plurality of sampling liquids 130 are able to be provided to a plurality of sections of the sampling area 112. The droplet controlling device 108 is then used for transporting the plurality of sampling liquids 130 respectively from the sampling area 112 to the detecting area 114 through the radial electrode rail 118b, the circular electrode rail 118a and another radial electrode rail 118b, so that the detecting area 114 includes therein the sampling liquids 130 of different compositions. After detection is complete, by using the droplet controlling device 108, the plurality of sampling liquids 130 are respectively transported from the each of the detecting area 114 to each of the recycling area 116 through the radial electrode rail 118b.

The rotating device 110 includes a carrier and a motor (not shown). The carrier shown in FIGS. 1 and 2 is used to represent the rotating device 110. The motor is used to directly (the carrier being directly installed on an axis of the motor) or indirectly (the carrier and the motor being connected through elements such as gears or transmission belts) drive the carrier to rotate. The substrate 106 is disposed on the carrier and directly rotates with the carrier or is directly driven by the motor to rotate. All types of rotating and driving techniques known to those with ordinary skill in the art are encompassed by the disclosure are hence not to be described herein.

According to an embodiment, the carrier includes grooves for housing the substrate 106. Alternatively, the carrier does not include grooves, so that the substrate 106 is directly disposed on the carrier.

According to an embodiment, the method of transporting the plurality of sampling liquids 130 respectively from the detecting area 114 to the recycling area 116 is as follows. The rotating device 110 is driven, so that the carrier installed with the substrate 106 rotates and generates a centrifugal force, and thus the sampling liquids 130 are spun off from the detecting area 114 to the recycling area 116. Under such circumstances, the electrode rails 118 may be disposed between the detecting area 114 and the recycling area 116 or may be omitted. Moreover, the sampling area 112 and the detecting area 114 are approximately located on one circumference of a circle. Furthermore, the recycling area 116 may be disposed at the outer periphery of the substrate 106; that is, on the outer periphery of the circle.

According to an embodiment, as shown in FIG. 2, the liquid transporting device 102 further includes a cover 124 which is used to cover the substrate 106. Furthermore, a first spacer 126 and a second spacer 128 are disposed on the substrate 106. The first spacer 126 is disposed to surround the sampling area 112 and includes a first outlet 126a. The second spacer 128 is disposed to surround the detecting area 114 and includes a first inlet 128a and a second outlet 128b. The first spacer 126 and the second spacer 128 prevent the sampling liquids 130 from being sputtered to other areas. The first spacer 126 and the second spacer 128 both have inverted U-shaped structures and include three walls. The second outlet 128b is an opening on the wall of the second spacer 128, thus providing an outlet to the recycling area 116.

The biochemical detecting apparatus 100 is, for example, a surface plasma resonance detecting apparatus or a fluorescent detecting apparatus. When the biochemical detecting apparatus 100 is a surface plasma resonance detecting apparatus, a surface of the substrate 106 has an optical grating structure, and the droplet controlling device 108 is disposed on the surface of the substrate 106 with the optical grating. Light is reflected when it passes through the sampling liquids and reaches the optical grating. Thus, by using the optical grating structure, polychromatic light is converted to monochromatic light of different wavelengths for the biochemical detecting apparatus 100.

Next, please refer to FIG. 3. FIG. 3 is a schematic cross-sectional diagram illustrating the detecting apparatus 100 at the droplet controlling device 108. The detecting apparatus 100 includes the substrate 106, the droplet controlling device 108, the droplet 140, a first hydrophobic layer 136, a second hydrophobic layer 138, a spacer 142, and a cover 124. The droplet controlling device 108 is disposed on the substrate 106 and includes an insulating layer 132, a plurality of first electrodes 134a, a plurality of second electrodes 134b, and a first hydrophobic layer 136. The insulation layer 132 is, for example, disposed on the carrier 106. Material of the insulation layer 132 is, for example, silicon oxide (SiO₂), silicon nitride (Si₃N₄), silicon oxynitride (SiOₓN_{y}), barium-strontium-titanium (BST), polymer, photoresist SU8, or parylene. The insulation layer 132 prevents the droplet 140 from directly contacting the first electrode 134a and the second electrode 134b.

Please refer to both FIGS. 2 and 3. The first hydrophobic layer 136 is disposed on the insulation layer 132. According to an embodiment, the first hydrophobic layer 136 is, for example, disposed on the surface of the electrode rail 118 and the sampling area 112. According to another embodiment, the first hydrophobic layer 136 covers, for example, an entire surface of the substrate 106 except an opening on the detecting area 114 for exposing a metal layer. In other words, the first hydrophobic layer 136 is not formed on the detecting area 114. Moreover, a compound with functional groups may be further implanted into the detecting area 114 to make the detecting area 114 hydrophilic. The second hydrophobic layer 138 is disposed on a surface of the cover 124 which faces the substrate 106. Material of the first hydrophobic layer 136 and the second hydrophobic layer 138 is, for example, tetrafluoro ethylene or cyclic fluoropolymer.

When the cover 124 covers the substrate 106, the spacer 142 (a collective term for the first spacer 126 and the second spacer 128) provides support and fixation for the cover 124, and a plurality of spaces which enable the droplet 140 to pass through are formed between the cover 124 and the substrate 106. By providing a relative voltage between the plurality of first electrodes 134a and the plurality of second electrodes 134b, the droplet 140 is driven from the sampling area 112 to the detecting area 114 in the spaces along the electrode rail 118.

The plurality of first electrodes 134a and the plurality of second electrodes 134b are disposed at different positions in the insulation layer 132 and are separated from each other. The plurality of first electrodes 134a and the plurality of second electrodes 134b are, for example, arranged in an interlaced linear or circular manner, so as to form the electrode rail 118.

Material of the plurality of first electrodes 134a and the plurality of second electrodes 134b is metal, for example, such as titanium, indium tin oxide, aluminum, copper, or gold. A method for forming the plurality of first electrodes 134a and the plurality of second electrodes 134b is as follows, for example. After forming the material of the electrodes on the substrate 106, shapes of the electrodes are formed thorough microelectromechanical processes such as exposure, lithography, and etching. As long as the shapes of the electrodes are able to provide a sufficient force for driving the droplet 140, the shapes are not particularly limited.

As shown in FIG. 4, a metal layer is disposed in the sampling area 112 and the detecting area 114. Material of the metal layer may be the same as or different from the material of the electrodes. According to the present embodiment, the material of the metal layer in the sampling area 112 and the detecting area 114 is the same as the material of the electrodes and is formed by the same process. The metal layer in the sampling area 112 and the detecting area 114, the plurality of first electrodes 134a and the plurality of second electrodes 134a are respectively connected to pads 146 through wires 144. By applying a voltage to the pads 146, different voltages are provided to the plurality of first electrodes 134a and the plurality of second electrodes 134b.

Please refer to both FIGS. 1 and 3. The biochemical detection apparatus 100 in the disclosure mainly includes the optical device 104 and the liquid transporting device 102. The optical device 104 is, for example, disposed on the liquid transporting device 102. The optical device 104 includes a light source 120 and a detector 122. A light from the light source 120 is incident on the detecting area 114 and forms a reflected light. The reflected light is emitted to the detector 122, which is used to detect a state of the reflected light. For example, when performing surface plasma resonance detection, through methods such as intensity interrogation, wavelength interrogation, and phase interrogation, the light (which may have a wavelength of 780 nm) from the light source 120 is incident on the detecting area 114 and is reflected by the detecting area 114. The detector 122 is used to detect a state of the reflected light. By using the detector 122, it is clearly shown that the state changes of the reflected light while comparing a metal thin film which does not contact the sampling liquids 130 and a metal thin film (the detecting area) which contacts the sampling liquids 130. The changes may include changes in light intensity, phase, and resonance wavelengths. Moreover, the metal thin film of the detecting area 114 with the compound with the functional groups implanted has a surface refraction rate that is different from a surface refraction rate of the metal thin film. When the compound with the functional groups binding with antigens in the sampling liquids, the surface refraction rate of the metal thin film with the compound with the functional groups implanted is changed. This method is also able to be applied in observation and determination of DNA and protein hybridization reactions or even determination of binding, dissociation abilities, and balance between chemical compounds. Different types of biochemical detection are able to be performed through the above method.

The liquid transporting device 102 includes the plurality of first electrodes 134a and the plurality of second electrodes 134b (positive and negative electrodes) on the substrate 106, and the insulation layer is covered on the electrode (the first electrodes 134a and the second electrodes 134b) to prevent the sampling liquids 130 from directly contacting the electrode (the first electrodes 134a and the second electrodes 134b). In order to reduce friction between the droplet 140 and the liquid transporting device 102 and/or the cover 124, a thin film (the first and second hydrophobic layers 136 and 138) with hydrophobic qualities may be optionally coated on the liquid transporting device 102 and/or the cover 124. Furthermore, if the sampling liquids 130 are biological samples, the first hydrophobic layer 136 is removed from the detecting layer 114 to facilitate reactions. The liquid transporting device 102 uses EWOD technique to provide a driving force for the droplet 140. When a voltage is applied between the two electrodes (the first electrodes 134a and the second electrodes 134b), the two electrodes (the first electrodes 134a and the second electrodes 134b) generate an induced electric field due to an electric potential. The induced electric field passes through an equivalent capacitor formed by the insulation layer and enters the droplet 140 to generate induced charges in the droplet 140, thereby changing a state of surface energy of the droplet 140 and changing the contact angle between the liquid and the solid. When the contact angles at two sides of the droplet 140 are unequal, an imbalance of forces occurs and the droplet moves. Hence the droplets 140 tend to stop at a location of dense electric fields to achieve balance. In order to control the movement of the droplet 140, all that needs to be done is applying voltages on the two electrodes (the first electrodes 134a and the second electrodes 134b) sequentially, and then the droplet 140 will move according to the switching sequence.

The above describes the biochemical detecting apparatus according to the disclosure; the following describes the biochemical detecting method according to the disclosure.

First, a biochemical detecting apparatus is provided. The biochemical detecting apparatus is, for example, the biochemical detecting apparatus shown in FIG. 1. The sampling liquid 130 is provided to the sampling area A. Then, the droplet controlling device 108 is driven to discretize the sampling liquid 130 into droplets 140, and a relative voltage is provided between the first electrodes and the second electrodes, so as to generate a driving force for the droplets 140, thereby transporting the sampling liquid 130 from the sampling area A to the detecting area 1. The sampling liquid 130 is transported from the sampling area A to the detecting area 1 by continuously supplying the droplets 140 of the sampling liquid 130, so that the droplets 140 enter the detecting area 1 in sequence.

When a sufficient amount of the sampling liquid 130 has entered the detecting area 1, the rotating device 110 is driven. The substrate 106 is rotated at a speed of, for example, 60 rpm to 120 rpm, so that the light from the light source 120 is incident on the detecting area 1 and forms the reflected light. The detector 122 is used to detect the state of the reflected light. Hence, the sampling liquid 130 is analyzed. The state of the reflected light may include light intensity, phase, and resonance wavelengths. After detection is complete, the sampling liquid 130 is removed from the detecting area 1.

During the step of removing the sampling liquid 130 from the detecting area 1, the droplet controlling device 108 is used for transporting the sampling liquid 130 from the detecting area 1 to the recycling area a. The sampling liquid 130 is transported from the detecting area 1 to the recycling area a by continuously supplying the droplets 140 of the sampling liquid 130, so that the droplets 140 enter the recycling area a in sequence.

According to the disclosure, during the step of removing the sampling liquid 130 from the detecting area 1, the rotating device 110 may also be driven to rotate the substrate 106 at a speed greater than 600 rpm, so as to spin off the sampling liquid 130 from the detecting area 1. The first spacer 126 and the second spacer 128 may be respectively disposed next to the detecting area 1 and the sampling area A, so as to against a certain degree of centrifugal force during detection. After detection is complete, the sampling liquid 130 is removed from the detecting area 1 by the centrifugal force generated from the rotation of the substrate 106.

According to another embodiment, different sampling liquids 130 may be respectively stored in the four sampling areas A, B, C, and D. Afterwards, the sampling liquids 130 are removed from the four sampling areas A, B, C and D to the electrode rail 118 as droplets 140 to enter the detecting area 1. The sampling liquids 130 in the remaining sampling areas B, C and D are also able to enter the detecting areas 2, 3, and 4 through the central circular electrode rail 118,such that the detecting areas 1, 2, 3, and 4 include mixtures of the different sampling liquids 130.

When the sampling liquids 130 of different compositions respectively enter the detecting areas 1, 2, 3, and 4, the rotating device 110 is driven to rotate the substrate 106 at a speed of 60 rpm to 120 rpm. The light from the light source 120 is incident on the detecting areas 1, 2, 3, and 4 and forms the reflected light. The detector 122 is used to detect the state of the reflected light. Hence, the sampling liquids 130 are analyzed. The state of the reflected light may include light intensity, phase, and resonance wavelengths. After detection is complete, the sampling liquids 130 are removed from the detecting areas 1, 2, 3 and 4.

During the step of removing the sampling liquid 130 from the detecting areas 1, 2, 3, and 4, the droplet controlling device 108 is used to transport the sampling liquids 130 from the detecting areas 1, 2, 3, and 4 to the recycling areas a, b, c, and d. The sampling liquids 130 are respectively transported from the detecting areas 1, 2, 3, and 4 to the recycling areas a, b, c, and d by continuously supplying the droplets 140 of the sampling liquids 130, so that the droplets 140 enter the recycling areas a, b, c and d in sequence.

According to the disclosure, during the step of removing the sampling liquids 130 from the detecting areas 1, 2, 3, and 4, the rotating device 110 may also be driven to rotate the substrate 106 at a speed greater than 600 rpm, so as to spin off the sampling liquid from the detecting areas 1, 2, 3, and 4. The first spacer 126 and the second spacer 128 may be disposed next to the detecting areas 1, 2, 3, and 4 and even the sampling areas A, B, C, and D to against a certain degree of centrifugal force during detection. After detection is complete, the sampling liquids 130 are removed from the detecting areas 1, 2, 3, and 4 to the recycling area a, b, c, and d by the centrifugal force generated from the rotation of the substrate 106.

In the above detecting method, the plurality of electrodes are disposed on the path of the moving droplet. By applying electricity to the electrodes, the angle between the liquid and the contact surface is changed. By applying electricity to the electrodes in order, the droplets move in a determined path.

In the above biochemical detecting method, if the compound with the functional groups is implanted on the metal thin film of the detecting area, the surface refraction rate of the detecting area is different from a surface refraction rate of the metal thin film. When the compound with the functional groups binds with antigens in the sampling liquids, the surface refraction rate of the metal thin film implanted with the compound with the functional groups is changed. This method is also able to be applied in observation and determination of DNA and protein hybridization reactions, or even determination of binding, dissociation abilities, and balance of chemical compounds. Different types of biochemical detection are able to be performed through the above method.

In summary, in the liquid transporting device, the biochemical detecting apparatus and method thereof according to the disclosure, since EWOD technique is used to control the liquids, no external pressure difference or external pumps are required as driving sources, so that the structure of the system is simplified, and the complexity of assembly is reduced. The volume of the system is also reduced, thereby achieving the goal of decreasing device costs.

Moreover, in the liquid transporting device, the biochemical detecting apparatus and method thereof according to the disclosure, EWOD technique is used to separate continuous liquids into droplets, so as to accurately control the sequence of the liquids being transported and mixed. By configuring the travel paths of the liquids and accurately controlling the quantity of the transported liquid, the goal of preventing miscalculation in the usage of the samples and waste is achieved.

The liquid transporting device, the biochemical detecting apparatus and the method thereof according to the disclosure are suitable for a surface plasma resonance method. If the compound with the functional groups is implanted on the metal thin film of the detecting area, the metal thin film implanted with the compound with the functional groups has a surface refraction rate different from a surface refraction rate of the metal thin film. When the compound with the functional groups binds with antigens in the sampling liquids, the surface refraction rate of the metal thin film implanted with the compound with the functional groups is changed. This method is also able to be applied in observation and determination of DNA and protein hybridization reactions or even determination of binding, dissociation abilities, and balance of chemical compounds. Different types of biochemical detection are able to be performed through the above method.

The liquid transporting device, the biochemical detecting apparatus, and the method thereof according to the disclosure are suitable for a fluorescent detecting method. If a to-be-detected material has characteristics of emitting fluorescent light after being irradiated by an energy-concentrated light beam (such as a laser beam), the material is able to be directly detected. By reading the intensity of the fluorescent light, positions, qualities, quantities, and concentrations of the to-be-detected material are able to be known. If a to-be-detected material does not have characteristics of emitting fluorescent light after being irradiated by an energy-concentrated light beam (such as a laser beam), the material is unable to be directly detected. The to-be-detected material may be tagged with fluorescent molecules, an energy-concentrated light beam with a specific wavelength (such as a laser beam) is used to excite the fluorescent molecules conjugated with the to-be-detected material, and by reading the intensity of the fluorescent light, positions, qualities, quantities, and concentrations of the to-be-detected material are able to be known. This enables greater performance in terms of sensitivity and selectivity.

On the other hand, the biochemical detecting apparatus and the method thereof are able to be used in tasks such as early-stage drug development, protein translation, and dynamic gene hybridization, thus saving samples and providing accurate quantization when accelerating the development or improvement of biopharmaceuticals, health foods, and agricultural biotechnology. When the biochemical detecting apparatus and method thereof are used in a medical detection and analysis laboratory, they are able to be easily used and save establishment costs.

It will be apparent to those skilled in the art that various modifications and variations can be made to the invention without departing from the scope or spirit of the invention. In view of the foregoing, it is intended that the invention cover modifications and variations of this invention provided they fall within the scope of the following claims and their equivalents.

What is claimed is:

1. A liquid transporting device, comprising:
a substrate; and
a droplet controlling device disposed on the substrate, for discretizing a sampling liquid into droplets and generating a driving force for the droplets to transport the sampling liquid, the droplet controlling device comprises:
at least one sampling area, used for carrying the sampling liquid;
at least one detecting area, used for detecting the sampling liquid; and
an electrode rail, disposed between the sampling area and the detecting area.

2. The liquid transporting device as claimed in claim 1, further comprising:
a first spacer, disposed to surround the sampling area and comprising a first outlet; and
a second spacer, disposed to surround the detecting area and comprising a first inlet and a second outlet.

3. The liquid transporting device as claimed in claim 1, wherein the substrate is a circular plate or a square plate, and a surface of the substrate having an optical grating structure.

4. The liquid transporting device as claimed in claim 3, wherein the droplet controlling device is disposed on the surface of the substrate having the optical grating structure.

5. The liquid transporting device as claimed in claim 1, wherein a material of the substrate is a plastic material.

6. The liquid transporting device as claimed in claim 1, further comprising:
at least one recycling area, used to recycle the sampling liquid in the detecting area;
the electrode rail, disposed between the sampling area and the recycling area.

7. The liquid transporting device as claimed in claim 1, wherein the electrode rail comprises a plurality of first electrodes and a plurality of second electrodes, wherein the first electrodes and the second electrodes are disposed adjacent to each other and are arranged in an interlaced linear or circular manner.

8. The liquid transporting device as claimed in claim 1, further comprising a first hydrophobic layer, disposed on a surface of the electrode rail.

9. The liquid transporting device as claimed in claim 1, wherein a compound with functional groups is implanted in the detecting area, so that the detecting area is hydrophilic.

10. The liquid transporting device as claimed in claim 8, further comprising a cover, so as to cover the substrate.

11. The liquid transporting device as claimed in claim 10, further comprising a second hydrophobic layer, disposed on a surface of the cover facing the substrate.

12. The liquid transporting device as claimed in claim 1, further comprising a rotating device, wherein the substrate is mounted on the rotating device.

13. The liquid transporting device as claimed in claim 1, wherein the droplet controlling device uses electrowetting on dielectric technique to discretize the sampling liquid into the droplets.

14. A detecting apparatus, comprising:
a liquid transporting device, comprising:
a substrate;
a droplet controlling device, disposed on the substrate and used to discretize a sampling liquid into droplets and to generate a driving force for the droplets, so as to transport the sampling liquid, the droplet controlling device comprises:
at least one sampling area;
at least one detecting area; and
an electrode rail, disposed between the sampling area and the detecting area;
a rotating device, wherein the substrate is mounted on the rotating device; and
a detector, detecting a reflected light reflected from the detecting area.

15. The detecting apparatus as claimed in claim 14, further comprising a light source, generating a light to incident on the detecting area.

16. The detecting apparatus as claimed in claim 14, further comprising:
at least one recycling area; and
the electrode rail, disposed between the sampling area and the recycling area.

17. The detecting apparatus as claimed in claim 14, wherein the electrode rail comprises a plurality of first electrodes and a plurality of second electrodes, wherein the first electrodes and the second electrodes are disposed adjacent to each other and are arranged in an interlaced linear or circular manner.

18. The detecting apparatus as claimed in claim 14, further comprising a first hydrophobic layer, disposed on a surface of the electrode rail.

19. The detecting apparatus as claimed in claim 14, wherein a compound with a biochemical functional group is implanted in the detecting area, so that the detecting area is hydrophilic.

20. The detecting apparatus as claimed in claim 14, further comprising a cover, so as to cover the substrate.

21. The detecting apparatus as claimed in claim 14, further comprising a second hydrophobic layer, disposed on a surface of the cover facing the substrate.

22. A detecting method, comprises:
providing a sampling liquid in at least one sampling area on a substrate;
driving a droplet controlling device to discretize the sampling liquid into droplets and generate a driving force for the droplets;
transporting the droplets from the sampling area to at least one detecting area;
driving a rotating device to rotate the substrate at a first rotating speed;
incidenting a light on the detecting area to generate a reflected light; and
detecting the reflected light to determine the sampling liquid.

23. The detecting method as claimed in claim 22, further comprises removing the sampling liquid from the detecting area.

24. The detecting method as claimed in claim 23, wherein the step of removing the sampling liquid from the detecting area comprises: driving the droplet controlling device to transport the sampling liquid from the detecting area to a least one recycling area.

25. The detecting method as claimed in claim 23, wherein the step of removing the sampling liquid from the detecting area comprises: driving the rotating device to rotate the substrate at a second rotating speed, so as to spin off the sampling liquid from the detecting area.

26. The detecting method as claimed in claim 22, wherein the first rotating speed is 60 rpm to 120 rpm.

27. The detecting method as claimed in claim 25, wherein the second rotating speed is greater than 600 rpm.

28. The detecting method as claimed in claim 22, wherein the substrate having an optical grating structure.

29. The detecting method as claimed in claim 22, wherein the step of transporting the droplets from the sampling area to the detecting area comprises:
providing a relative voltage between a plurality of first electrodes and second electrodes, wherein the first and second electrode are disposed between the sampling area and the detecting area;

30. The detecting method as claimed in claim 22, further comprising implanting a compound with functional groups in the detecting area.

31. The detecting method as claimed in claim 22, wherein the droplet controlling device uses electrowetting on dielectric technique to discretize the sampling liquid into the droplets.
